(19) United States
(12) Patent Application Publication
(10) Pub. No.: US 2004/0122999 A1
(43) Pub. Date: Jun. 24, 2004

(54) System and method for notifying device information in response to user request

(75) Inventors: Junichi Okuyama, Ashigarakami-gun (JP); Katsuya Mitsutake, Ashigarakami-gun (JP); Koichi Yoshimura, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/704,968

(22) Filed: Nov. 12, 2003

(30) Foreign Application Priority Data
Dec. 19, 2002 (JP) 2002-368229

(51) Int. Cl. G06F 3/00

(52) U.S. Cl. 710/52; 710/1

(57) ABSTRACT

A device which is a network adaptable device comprises a request input section for inputting an email address designated by a user, as a device information acquisition request and an information transmission processing section for transmitting a network address and device attribute information of the device as device information to a user terminal device while addressing to the email address input via the request input section. The user terminal device comprises an information acquisition section for obtaining the device information transmitted from the device. An email address can be designated via the device, which may be located in front of the user, and the user obtains a network address or the like of the device. As described above, device information of the device which the user wishes to use can readily be obtained.

### BACKGROUND OF THE INVENTION

1. Field of the Invention

The present invention relates to a method for notifying a user of a network address or the like in response to a request from the user who wishes to obtain a network address assigned to a device, such as a facsimile and a printer, which is connected to a computer network and its device attribute information in order to use the connected device.

2. Description of the Related Art

Many computer networks are now configured to allow connection with various devices beyond ordinary network adaptable devices such as facsimiles, printers, and scanners, devices such as projectors, white boards, and so forth.

In addition, as the scale of company intranets (internal networks) has been enlarged, it has become not uncommon for networks to be administered in sub-units. That is, the entire network is divided into units of organizations, such as one office, division, or the like, in consideration of network load or administration or the like, and a network administrator is assigned to each of the smaller scale sectional networks for administrative purposes. In such cases, the system environment is determined such that a user is allowed to access only devices which are connected to a sectional network associated with that user.

To enable access to devices connected to a network, a unique network address is assigned to each device connected to the network so that a user can send data including a designation of a network address from a terminal device through the network, to cause the device which the user wishes to use to perform a desired operation, such as printing. A user who wishes to receive data may supply his own network address as a data transmission designation address when sending a data transmission request in order to have desired data sent to him from a network adaptable device. As described above, a network address is used by both user terminal devices and network adaptable devices in order to mutually recognize a device connected to the network in data exchange operation.

Generally, in a sectional network associated with a division of a corporation, network addresses of network adaptable devices connected to the sectional network are registered in advance in the respective user terminal devices used by users in that division. This arrangement allows the users to use a desired network adaptable device without being bothered about a network address. In addition, as users may, based on their daily experience with the devices, be familiar with the attribute information of the network adaptable devices they usually use, such as, for example, sheet size, print color, print speed, and the like of a printer, the users can select an appropriate network adaptable device for his work from among those connected to the network.

Here, even in situations such as one in which a user transferred to a different division begins to use a network adaptable device associated with his new division, one in which a user wishes to temporarily use a network adaptable device associated with a division other than the division to which he belongs, or one in which a user wishes to use a network adaptable device installed in a site for public use, such as, for example, a convenience store, each of those users must know the network address of the network adaptable device he whishes to use, as described above. A user without specific knowledge of the network address cannot use the network adaptable device, even if the network adaptable device is sitting in front of the user. Although the user could obtain the network address from someone such as a network administrator, a knowledgeable fellow user, or a person in charge of network adaptable devices, if no such person is available, the user will be unable to obtain the address.

Conventionally, as one of the solutions to this problem, a user sends a request for transmission of network address and device attribute information to the device which they wish to use, and, in response to the request, the device informs the user of its own network address and device attribute information, so that the user can know the network address and device attribute information of the device he wishes to use (a service discovery method).

Here, “device attribute” refers to information concerning functions and capabilities of a device. When a device is a printer, for example, the device attribute may include “network host name”, “device serial number”, “device model name”, “device manufacturer name”, “applicable protocols”, “administration organization”, “printable sheet sizes (A4, B4, letter, and so forth), “page rotation printing applicability (upside-down, left-right reverse, mirror reverse, or the like)”, “page reordering printing applicability”, “n-up mode applicability (printing a document for n number of pages on one page)”, “sorter availability”, “two-side printing applicability”, “enlarged or reduced size printing applicability”, “print resolution (200 dpi (dots per inch), 300 bpi, or the like)”, “print color (black and white, n number of colors, or the like)”, “print gradation number (1 bpp (bits per pixel) for a black-and-white print, 16 bpp for a color print, and so forth)”, “print speed (ppm (pages per minutes, or the number of pages to print per minute)”, “negative-positive reverse printing applicability”, and so forth. Examples of service discovery methods include, for example, UPnP and Bluetooth.

Another available method may be a UI method in which each device has a user interface for presenting its network address so that a user can know the network address through the user interface.

According to the service discovery method, however, because device information regarding devices connected to a network covered by a service attribute response means are all informed to the user, the user may be informed of device information of not only the device which the user wishes to use but also of other devices. Thus, the user must specify the information of the device which the user wishes to use from among all of the provided network address information or the like. However, there is only one method presently available which is usable in such specification. According to this method, that is, a trial method, a user selects one address from all of the network addresses informed, assuming that the address is the address of the device which the user wishes to use, and designates the address to actually use in trial data exchange. Therefore, two or more trials may be necessary. This is troublesome and time consuming.

Meanwhile, according to the UI method, although this method can uniquely specify a network address, in order to actually use the address in a user terminal device, the user must record the presented network address by, for example, writing it down on a memo and then manually inputting the address into the user terminal device. This is also troublesome. Moreover, because the UI method does not present device attribute information, the user cannot know if the printer he wishes to use is adapted to a printing function he wishes to utilize. For example, when a user wishes to print on a metric size A3 sheet of paper using a printer physically available in front of them, because no attribute information is available, the user cannot know if the printer can actually print on A3 size paper. Therefore, similar to the service discovery method, the UI method may also requires trial printing or inquiring of a person who is familiar with the device attribute of the printer as to if the printer is capable of printing the user desires.

### SUMMARY OF THE INVENTION

The present invention has been conceived in order to obviate the above described shortcomings, and advantageously provides a device information notification system, a device information notification device, and a device information notification method for allowing a user to readily obtain device information of a device which the user wishes to use.

According to one aspect of the present invention, there is provided a device information notification system for notifying a user of device information of a device connected to a network which the user uses, comprising request input means for inputting a transmission destination designated by the user; information transmission processing means for transmitting device information of a device specified by the user to the transmission destination input by the request input means; and information acquisition means provided to a user terminal device used by the user, for obtaining the device information transmitted by the information transmission processing means.

With this arrangement, device information of just the device which the user wishes to use can be notified to the transmission destination which is designated by the user by inputting. Therefore, the user can readily obtain the device information of just the device which they wish to use, without receiving device information of other devices connected to the same network to which the device which the user wishes to use is connected.

In one embodiment of the present invention, when it is determined that information storage means is designated as a transmission destination, the information transmission processing means may store the device information in the information storage means, rather than sending the device information, and the information acquisition means may obtain the device information from the information storage means.

According to another aspect of the present invention, there is provided a device information notification system for notifying a user of device information of a device connected to a network which the user uses, comprising request input means for inputting a device information acquisition request designated by the user; information transmission processing means for transmitting reference destination information of device information of a device specified by the user according to the device information acquisition request input by the request input means; and information acquisition means provided to a user terminal device used by the user, for obtaining the device information based on the reference destination information transmitted by the information transmission processing means.

With this arrangement, reference destination information of the device information of the device which the user wishes to use can be notified in response to the device information acquisition request designated by the user by inputting. Alternatively, the device information may be stored in the information storage means, in response to user designation. With either of these arrangements, the user can obtain the device information based on the reference destination information or from the information storage means. In the acquisition of the information, the user can obtain the device information of only the device which the user wishes to use, but not of other devices.

In one embodiment of the present invention, the request input means and the information transmission processing means may be provided to a device corresponding to the device information obtained by the user.

Further, the request input means may be provided to the device for which the device information is notified to the user, and the information transmission processing means may be provided to an administration device of a network to which the device is connected.

Still further, the request input means and the information transmission processing means may be provided to an administration device of a network to which the device is connected.

Yet further, the request input means and the information transmission processing means may be provided respectively to different administration devices of a network to which the device is connected.

Yet further, the device information may contain at least one of a network address and device attribute information of the device.

According to still another aspect of the present invention, there is provided a device information notification device for notifying a user of device information of a device connected to a network which the user uses, comprising request input means for inputting a transmission destination to which the user is able to access and designated by the user; and information transmission processing means for transmitting device information of a device specified by the user to the transmission destination input by the request input means.

In one embodiment, when it is determined that information storage means is designated as a transmission destination, the information transmission processing means may store the device information in the information storage means, rather than sending, and the information acquisition means may obtain the device information from the information storage means.

According to yet another aspect of the present invention, there is provided a device information notification device for notifying a user of device information of a device connected to a network which the user uses, comprising request input means for inputting a device information acquisition request designated by the user; and information transmission processing means for transmitting reference destination information of device information of a device specified by the user according to the device information acquisition request input by the request input means; wherein the user obtains the device information based on the reference destination information.

In one embodiment, the device information may contain at least one of a network address and device attribute information of the device.

According to yet another aspect of the present invention, there is provided a device information notification method for notifying a user of device information of a device connected to a network which the user uses, comprising a transmission destination input step of inputting a transmission destination designated by the user; a device information transmission step of transmitting device information of a device specified by the user to the transmission destination input at the transmission destination input step; and device information acquisition step of obtaining, in a user terminal device used by the user, the device information transmitted at the device information transmission step.

In one embodiment, when it is determined that information storage means is designated as a transmission destination, the device information is stored, rather than being transmitted, in the information storage means at the device information transmission step, and the device information is obtained from the information storage means at the information acquisition step.

According to yet another aspect of the present invention, there is provided a device information notification method for notifying a user of device information of a device connected to a network which the user uses, comprising a request input step of inputting a device information acquisition request designated by the user; an information transmission step for transmitting reference destination information of device information of a device specified by the user according to the device information acquisition request input at the request input step; an information receiving step of obtaining, in a user terminal device used by the user, the reference destination information transmitted at the information transmission step; and a device information acquisition step of obtaining, in the user terminal device, the device information based on the reference destination information received at the (device ?) information receiving step.

In one embodiment, the above described method may further comprise an information presenting step of presenting to the user the device information received at the device information acquisition step.

In one embodiment, the device information may contain at least one of a network address and device attribute information of the device.

### BRIEF DESCRIPTION OF THE DRAWINGS

FIG. 1 is a block diagram showing a structure of a device information notification system according to a first embodiment of the present invention;

FIG. 2 is a diagram showing a sequence of processing in the first embodiment of the present invention;

FIG. 3 is a diagram showing an example of content of device information in the case where the device is a printer in the first embodiment of the present invention;

FIG. 4 is a block diagram showing a structure of a device information notification system according to a second embodiment of the present invention;

FIG. 5 is a block diagram showing a structure of a device information notification system according to a third embodiment of the present invention; and

FIG. 6 is a block diagram showing a structure of a device information notification system according to a fourth embodiment of the present invention.

### DESCRIPTION OF THE PREFERRED EMBODIMENTS

In the following, preferred embodiments of the present invention will be described with reference to the accompanied drawings.

### Embodiment 1

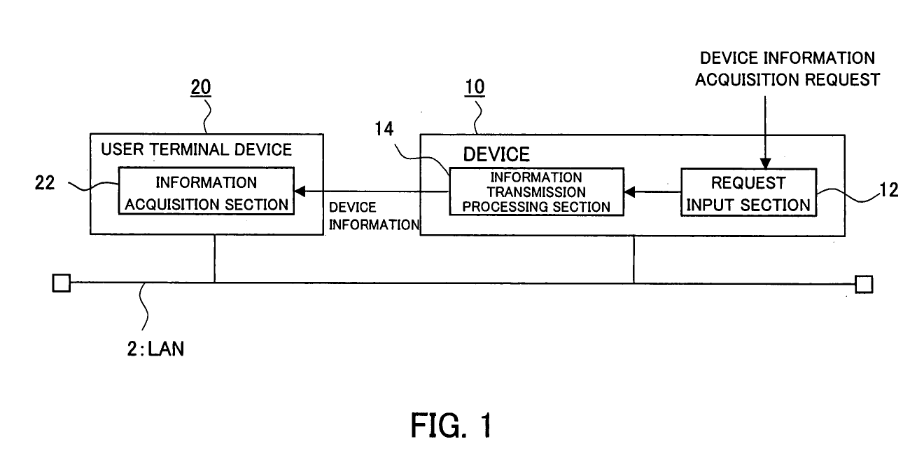

FIG. 1 is a block diagram showing a structure of a device information notification system according to a first embodiment of the present invention. The drawing shows a device 10 and a user terminal device 20, both connected to a LAN (Local Area Network) 2, which is a computer network in the present invention. A user uses the device 10 by operating the user terminal device 20, both of which are connected to the same LAN 2.

The device 10 represents a network adaptable device such as a facsimile, a printer, a scanner, or the like. Although only one device is shown in FIG. 1, a plurality of devices 10, regardless of their type, which may be same or different, may be connected. The device 10 comprises a request input section 12 and an information transmission processing section 14. The request input section 12 is used to input a device information acquisition request designated by a user. When email, for example, is used for acquisition of device information by the user terminal device 20, as will be described in this embodiment, an email address is designated by inputting as a device information acquisition request via the request input section 12. In return, the information transmission processing section 14 transmits device information on a concerned device 10, addressing to the email address input via the request input section 12.

The user terminal device 20 is an information processing device, such as a personal computer (PC), used by a user and capable of data exchange with a device 10 connected to the LAN 2 while utilizing a network address. The user terminal device 20 has an information acquisition section 22 for receiving device information sent from the device 10 through the LAN 2. Device information received by the user terminal device 20.may include a network address and device attribute information on the device 10 in this embodiment.

The present embodiment is characterized in that a device information acquisition request is input for designation, from a device 10 which the user wishes to use, so that the user can obtain device information of the device 10. With this arrangement, a user can readily obtain the device information of only the device 10 which the user wishes to use, without receiving device information of other devices, by merely designating a device information acquisition request by inputting.

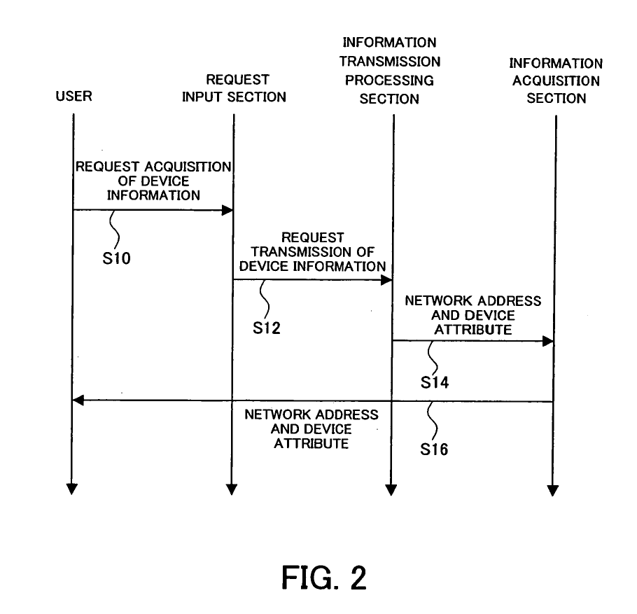

In the following, processing in this embodiment will be described with reference to the sequence shown in FIG. 2.

In order to use a device 10 which is connected to the LAN 2 and physically available in front of a user, the user designates an email address to which he can access as a device information acquisition request by inputting using a user interface of the device 10. In return, the request input section 12 receives the request (S10). At this time, the user does not know the network address of the device 10. A user interface provided by the request input section 12 may be, for example, in the form of a Web page described in an HTML (Hypertext Markup Language). Thus, the user inputs an email address using a form published on a predetermined Web page, as described above. The request input section 12 sends a device information transmission request containing the received email address to the information transmission processing section 14 (S12). A device information transmission request may be created utilizing a typical format, such as an XML (Extensible Markup Language) format, as an XML format document.

Having received the device information transmission request, the information transmission processing section 14 creates device information which contains a network address and attribute information stored in the device 10. After analyzing the XML format document to determine that an Internet email address is designated as a transmission designation, the information transmission processing section 14 sends an email to the address designated in the device information transmission request, according to the SMTP (Simple Mail Transfer Protocol) (S14).

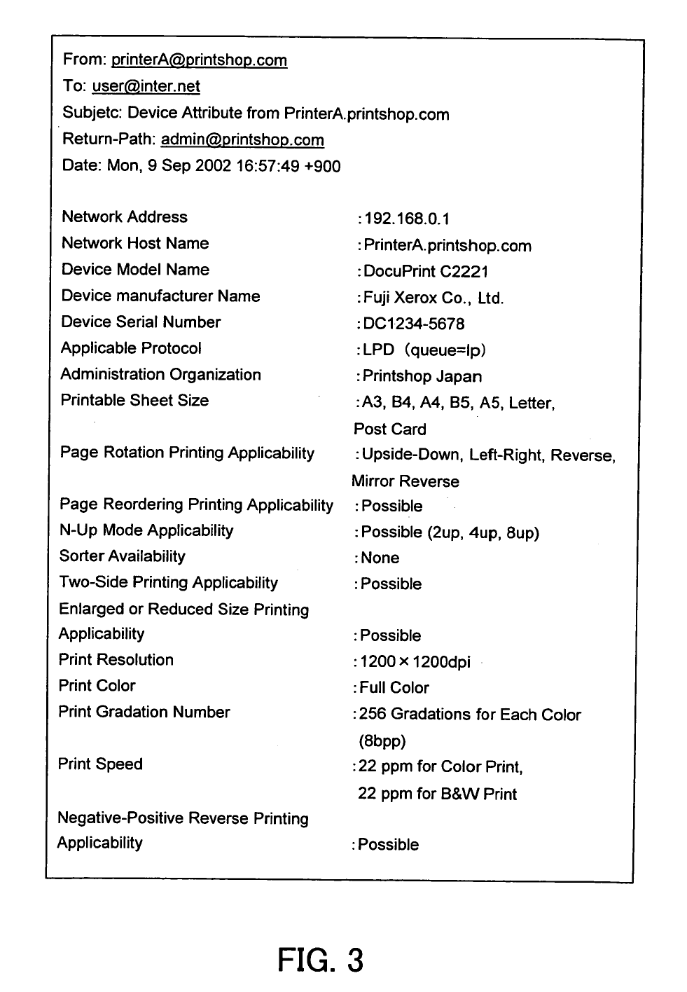

The information acquisition section 22 of the user terminal device 20 receives the email message, and, thus, device information, from the device 10 according to the POP 3 (Post Office Protocol Version 3) or APOP (Authenticated Post Office Protocol) (S16). Then, the information acquisition section 22 can present the device information included in the received email to the user by utilizing an appropriate mail function. As described above, the user can readily obtain the desired device information. FIG. 3 shows the content of device information of a device 10, which is a printer.

According to this embodiment, designation of an address at which a user can receive device information, by inputting via a device 10 which the user wishes to use, is the sole requirement for the user to readily obtain necessary device information.

It should be noted that, although an email address is input as a device information acquisition request in the above, a device information acquisition request is not limited to an email address. For example, when the information acquisition section 22 is realized using a Web browser and not a mailer, the user may designate as a device information acquisition request that a Web browser be used as an information acquisition means. Then, based on this request, the request input section 12 similarly sends a device information transmission request to the information transmission processing section 14.

The information transmission processing section 14 analyzes the device information transmission request in the form of an XML format document sent from the request input section 12 and, when it is determined that the user's information acquisition means is a Web browser, sends to the device 10 a URL (Uniform Resource Locator) as reference destination information which leads to an HTML format document where a network address and device attribute information are described. Alternatively, the URL may be, for example, directed to the user by means of an Internet email or output via a user interface of the device 10 which is placed in front of the user and designated by the user as a device information acquisition request. With this arrangement, the user can review the Web page according to the HTTP (Hypertext Transfer Protocol) based on the designated URL and obtain the desired device information.

In an alternative example in which the information acquisition section 22 is realized utilizing an RDB (Relational Database) using an SQL (Structured Query Language), the user designates the names of an RDB and a table for registration of device information, as a device information acquisition request. The information transmission processing section 14 analyzes the device information transmission request in the form of an XML format document sent from the request input section 12 and, when it is determined that the user's information receiving means utilizes an RDB which uses an SQL, creates an SQL to use to store the device information in the RDB and registers, rather than sends, the device information in the RDB. Registration can be achieved using an ODBC (Open Database Connectivity). If the information transmission processing section 14 adds user information to the device information, the user having received device information from the RDB can readily know that the received device information is the device information he requested.

As described above, the user can obtain device information from a predetermined table in the RDB by using an ODBC and an SQL, which is used in the information acquisition section 22. In this case, completion of registration to the RDG may be notified to the user using an email.

### Embodiment 2

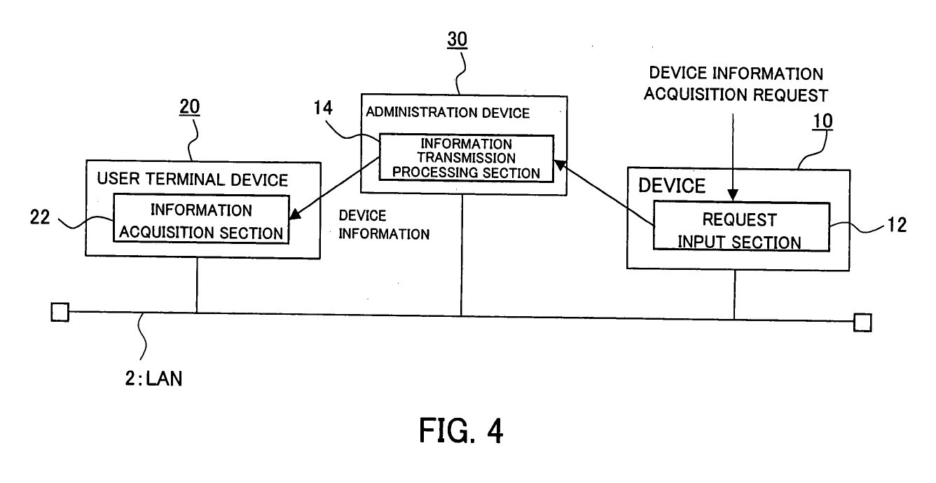

FIG. 4 is a block diagram schematically showing the structure of a device information notification system in a second embodiment of the present invention. In the drawing, identical elements to those in the first embodiment are identified by identical reference numerals. This is also applicable to other embodiments as will be described later.

In the structure shown in FIG. 4, a network administration device 30 is additionally provided to the computer network. Whereas the request input section 12 and the information transmission processing section 14 are included in the device 10 in the first embodiment, the information transmission processing section 14 is included in the administration device 30 in this embodiment.

Some of today's network adaptable devices are highly sophisticated and can function as a single information terminal device having a CPU, a memory, and so forth. That is, there are actually available such devices 10, as described in Embodiment 1, that have a user interface having an input/output function which is necessary to realize the request input section 12 and any function (Web-applicable, RDB applicable, and so forth) which is necessary to realize the information transmission processing section 14. However, it is not the case that all of the devices 10 have such functions.

In this embodiment, in order to apply the present invention to a device 10 which lacks a function necessary to realize the information transmission processing section 14, the information transmission processing section 14 is provided to the administration device 30. As being realized using a personal computer, the administration device 30 can possess a. Web function, RDB, and so forth.

It should be noted that the structure in this embodiment other than provision of the information transmission processing section 14 to the administration device 30 is identical to that in the first embodiment. Processing in this embodiment is also identical to that in the first embodiment and thus not described here, and can produce identical advantages to those provided in the first embodiment.

### Embodiment 3

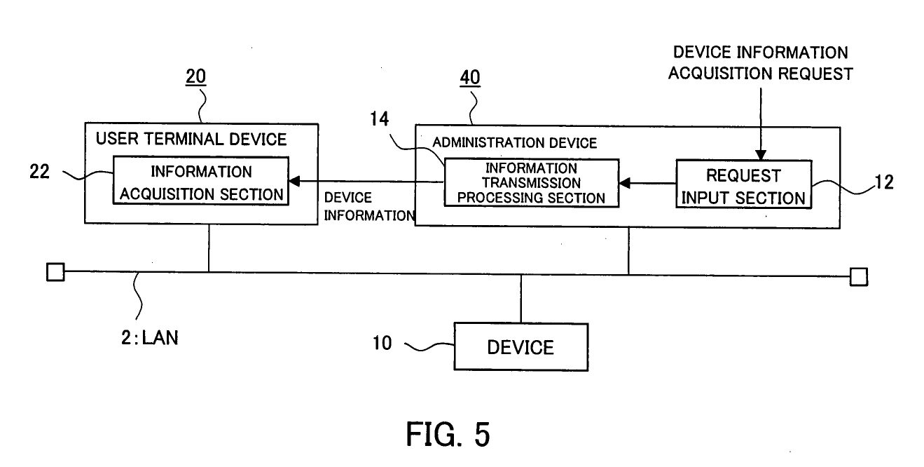

FIG. 5 is a block diagram schematically showing a structure of a device information notification system in a third embodiment of the present invention. Whereas the information transmission processing section 14 is provided to the administration device 30 and the request input section 12 is provided to the device 10 in the second embodiment, the request input section 12 and the information transmission processing section 14 are both provided to the administration device 40 in this embodiment in order to apply the present invention to a device 10 which also lacks a function necessary to realize the request input section 12. In this case, if a plurality of devices 10 are connected to the LAN 2, in order to specify the device 10 among the plurality of devices 10, from which the user wishes to obtain device information, the user must include information for specifying the device 10 in a device information acquisition request.

It should be noted that the structure of this embodiment, other than provision of the request input section 12 and the information transmission processing section 14 to the administration device 40, is identical to that in the first embodiment. Processing in this embodiment is also identical to that in the first embodiment and thus not described here, and can produce identical advantages as those provided by the present invention when configured according to the first embodiment.

### Embodiment 4

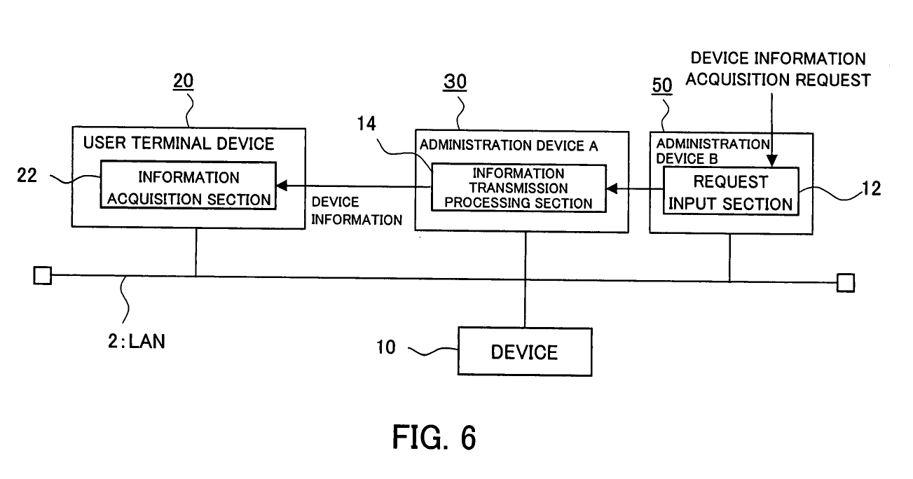

FIG. 6 is a block diagram schematically showing a structure of a device information notification system in a fourth embodiment of the present invention. Whereas the request input section 12 and the information transmission processing section 14 are provided to a single common administration device 40 in the third embodiment, these sections may be separately provided to an administration device 30 and an administration device 50, respectively. Processing in this embodiment is identical to that in the first embodiment and thus not described here, and can produce identical advantages as those provided by the present invention when configured according to the first embodiment.

It should be noted that, although a user terminal device, a network adaptable device, and an administration device are all connected to the same small-scale network (LAN) in the examples used to illustrate the above embodiments, these devices may be located on different small-scale networks, as long as the devices can communicate to one another via the networks.

It should also be noted that, although it is described that device information contains a network address and device attribute information in the above embodiments, in a case where either a network address or device attribute information is already obtained using other methods, only one of the network address and the device attribute information which is yet to be obtained may be contained in device information.

What is claimed is:

1. A device information notification system for notifying a user of device information of a device connected to a network which the user uses, comprising:
request input means for inputting a transmission destination designated by the user;
information transmission processing means for transmitting device information of a device specified by the user to the transmission destination input by the request input means; and
information acquisition means provided to a user terminal device used by the user, for obtaining the device information transmitted by the information transmission processing means.

2. The device information notification system according to claim 1, wherein, when it is determined that information storage means is designated as a transmission destination, the information transmission processing means stores the device information in the information storage means rather than sending the device information, and the information acquisition means obtains the device information from the information storage means.

3. The device information notification system according to claim 1, wherein the request input means and the information transmission processing means are provided to a device corresponding to device information obtained by the user.

4. The device information notification system according to claim 1, wherein the request input means is provided to the device for which the device information is notified to the user, and the information transmission processing means is provided to an administration device of a network to which the device is connected.

5. The device information notification system according to claim 1, wherein the request input means and the information transmission processing means are provided to an administration device of a network to which the device is connected.

6. The device information notification system according to claim 1, wherein the request input means and the information transmission processing means are provided to different administration devices of a network to which the device is connected.

7. The device information notification system according to claim 1, wherein the device information contains at least one of a network address and device attribute information of the device.

8. A device information notification system for notifying a user of device information of a device connected to a network which the user uses, comprising:
request input means for inputting a device information acquisition request designated by the user;
information transmission processing means for transmitting reference destination information of device information of a device specified by the user in response to the device information acquisition request input by the request input means; and
information acquisition means provided to a user terminal device used by the user, for obtaining the device information based on the reference destination information transmitted by the information transmission processing means.

9. The device information notification system according to claim 8, wherein the request input means and the information transmission processing means are provided to a device corresponding to device information obtained by the user.

10. The device information notification system according to claim 8, wherein the request input means is provided to the device for which the device information is notified to the user, and the information transmission processing means is provided to an administration device of a network to which the device is connected.

11. The device information notification system according to claim 8, wherein the request input means and the information transmission processing means are provided to an administration device of a network to which the device is connected.

12. The device information notification system according to claim 8, wherein the request input means and the information transmission processing means are respectively provided to different administration devices of a network to which the device is connected.

13. The device information notification system according to claim 8, wherein the device information contains at least one of a network address and device attribute information of the device.

14. A device information notification device for notifying a user of device information of a device connected to a network which the user uses, comprising:
request input means for inputting a transmission destination to which the user is able to access and designated by the user; and
information transmission processing means for transmitting device information of a device specified by the user to the transmission destination input by the request input means;

15. The device information notification device according to claim 14, wherein, when it is determined that information storage means is designated as a transmission destination, the information transmission processing means stores the device information in the information storage means rather than sending the device information, and the information acquisition means obtains the device information from the information storage means.

16. The device information notification device according to claim 14, wherein the device information contains at least one of a network address and device attribute information of the device.

17. A device information notification device for notifying a user of device information of a device connected to a network which the user uses, comprising:
request input means for inputting a device information acquisition request designated by the user; and
information transmission processing means for transmitting reference destination information of device information of a device specified by the user according to the device information acquisition request input by the request input means;
wherein
the user obtains the device information based on the reference destination information.

18. The device information notification device according to claim 17, wherein the device information contains at least one of a network address and device attribute information of the device.

19. A device information notification method for notifying a user of device information of a device connected to a network which the user uses, comprising:
a transmission destination input step of inputting a transmission destination designated by the user;
a device information transmission step of transmitting device information of a device specified by the user to the transmission destination input at the transmission destination input step; and
device information acquisition step of obtaining, in a user terminal device used by the user, the device information transmitted at the device information transmission step.

20. The device information notification method according to claim 19, wherein, when it is determined that information storage means is designated as a transmission destination, the device information is stored, rather than being transmitted, in the information storage means at the device information transmission step, and the device information is obtained from the information storage means at the information acquisition step.

21. The device information notification method according to claim 19, further comprising an information presenting step of presenting to the user the device information received at the device information acquisition step.

22. The device information notification method according to claim 19, wherein the device information contains at least one of a network address and device attribute information of the device.

23. A device information notification method for notifying a user of device information of a device connected to a network which the user uses, comprising:
a request input step of inputting a device information acquisition request designated by the user;
an information transmission step for transmitting reference destination information of device information of a device specified by the user according to the device information acquisition request input at the request input step;
an information receiving step of obtaining, in a user terminal device used by the user, the reference destination information transmitted at the information transmission step; and
a device information acquisition step of obtaining, in the user terminal device, the device information based on the reference destination information received at the information receiving step.

24. The device information notification method according to claim 23, further comprising an information presenting step of presenting to the user the device information received at the device information acquisition step.

25. The device information notification method according to claim 23, wherein the device information contains at least one of a network address and device attribute information of the device.
